(19) United States
(12) Patent Application Publication
(10) Pub. No.: US 2011/0145494 A1
(43) Pub. Date: Jun. 16, 2011

(54) VIRTUAL TAPE SERVER AND METHOD FOR CONTROLLING TAPE MOUNTING OF THE SAME

(75) Inventors: Shinsuke Mitsuma, Tokyo-to (JP); Toshiyasu Motoki, Kanagawa-ken (JP); Yutaka Oishi, Kanagawa (JP); Hyeong-Ge Park, Kanagawa (JP)

(73) Assignee: INTERNATIONAL BUSINESS MACHINES CORPORATION, Armonk, NY (US)

(21) Appl. No.: 12/947,155

(22) Filed: Nov. 16, 2010

(30) Foreign Application Priority Data
Dec. 14, 2009 (JP) 2009-283204

(51) Int. Cl. G06F 12/08

(52) U.S. Cl. 711/111; 711/E12.019

(57) ABSTRACT

A method of a virtual tape server (VTS) for processing a mount request from a host system, the method comprising the steps of receiving a logical-volume (LVOL) mount request from the host system using a virtual-tape drive (VTD) of the virtual tape server; determining whether the logical volume is present in a virtual storage region (cache) using a controller in the virtual tape server; determining using the controller, if it is determined that the logical volume is not present in the virtual storage region, whether the mount request is a write request; and notifying, if it is determined that the mount request is a write request, the host system of completion of the mounting without reading the requested logical volume from a physical tape library that is externally connected to the virtual tape server into the virtual storage region.

### CROSS-REFERENCE TO RELATED APPLICATIONS

This application claims priority under 35 U.S.C. §119 to Japanese Patent Application No. 2009-283204 filed on Dec. 14, 2009, the entire text of which is specifically incorporated by reference herein.

### BACKGROUND

1. Field of the Invention

The present invention relates to a virtual tape server (VTS) and a method for controlling tape mounting of the same. More specifically, the present invention relates to a method for reducing a logical-tape-volume mounting time and a virtual tape server that implements the method.

2. Background of the Related Art

Magnetic tape is used to store a large volume of data, such as to back up information stored in a hard disk, because of the large memory capacity. However, since access speed to magnetic tape is low, a virtual-tape storage server (VTS) (hereinafter referred to as a VTS or a virtual tape server) in which a hard disk that can be accessed at a higher speed is used instead of magnetic tape was developed as a storage medium of a host computer. The virtual tape server enables access to a storage medium at a higher speed than a physical tape unit by virtually emulating a tape unit on a hard disk connected to a host system.

The virtual tape server (VTS) virtualizes a tape volume, and the tape volume on the VTS handled by a host application is present in the VTS as a logical volume (also referred to as LVOL, a logical tape volume, or a virtual tape volume). The logical volume is present in a disk device, under the control of the VTS, called a cache serving as a virtual storage region or in a physical tape library also under the control of the VTS. The logical volume present in the cache is transferred (hereinafter referred to as “migrate” or “migration”) to a physical tape volume (hereinafter referred to as a physical volume) in the physical tape library if the LVOL is not referred to for a long time or in accordance with a storage management policy.

If a certain logical volume (LVOL) is present in the cache, a mount request to the logical volume can be executed without mounting a physical volume. In contrast, if a certain logical volume is not present in the cache and has already been migrated to a physical volume, the VTS can execute the mount request from the host system by mounting the physical volume (for example, a tape cartridge) to a physical device (for example, a tape drive) and reading (copying) data on the logical volume into the cache. The reading (copying) of LVOL data on the physical volume into the cache is generally referred to as recall.

As viewed from the host application side, while the time required to mount a logical volume in the cache is supposed to be in units of milliseconds, the processing time required to mount a logical volume, which needs migration of data from a physical volume to the cache, that is, recall, is in units of minutes because it needs mounting a physical tape that is a physical volume in which the data of the logical volume is present and reading into the cache. Accordingly, it is important to consider a mount request from the host system and a mount processing time for the request, that is, mount performance.

The LVOL mount request from the host system to the VTS is either a specific-volume mount request or a non-specific-volume mount request. In the specific-volume mount request, when a mount request for a tape volume given a volume serial number used by the host application is made, the operating system of the host makes a request to mount the tape volume of the volume serial number to the VTS. Thus, the specific-volume mount request is a mount request that designates a specific tape volume and is used in UNIX®-like operating systems (OSs).

In contrast, the non-specific-volume mount request does not designate a specific tape volume. A tape volume requested by the host application is any “empty volume” (any volume serial number is possible provided that it is an empty volume). The operating system of the host makes a request to mount a tape volume defined as “empty volume” on the host system to the VTS in response to this request. This non-specific-volume mount request is used in mainframe operating systems (OSs) represented by IBM System z/OS™ and is generally used only for writing.

Since the non-specific-volume mount request is used for writing, and moreover has an attribute classified as “empty volume” as viewed from the host, a space for a logical volume has only to be provided in the cache, and a recall process is not needed.

A recall occurs in the virtual tape server (VTS) when the specific-volume mount request is made. At the time when the host system makes a mount request to the VTS, it cannot be determined whether an application that makes the tape mount request performs reading or writing. Therefore, it is necessary for the VTS to perform a recall in the case where there is effective data for the requested logical volume, and the data is present not in the cache but in a controlled physical volume externally connected to the VTS.

With UNIX-like OSs that use only the specific-volume mount request, the VTS cannot discriminate whether to write to or read from the logical volume from the VTS. In the case where, when mounting a logical volume to the VTS, the data of the LVOL is not present in the cache (disk device), it takes time in minutes to copy the LVOL data from the physical tape into the cache as described above. Accordingly, the mounting performance of an application that performs writing in response to the specific-volume mount request can be degraded due to an increase in mount processing time.

In general, the VTS first receives a LVOL mount request from the host system to perform writing to the tape unit. In response to receiving the mount request, the control program of the VTS refers to the space map of a virtual storage region. If the requested LVOL is not present in the virtual storage region, there is a need for the processes of copying the LVOL data from a physical tape in the physical tape library into the virtual storage region, and after completion of the copying, notifying the completion of mounting to the host system by the VTS, and writing the data onto the tape unit by the host system that has received the notification.

### BRIEF SUMMARY

A method of a virtual tape server (VTS) for processing a mount request from a host system, the method comprising the steps of receiving a logical-volume (LVOL) mount request from the host system using a virtual-tape drive (VTD) of the virtual tape server; determining whether the logical volume is present in a virtual storage region (cache) using a controller in the virtual tape server; determining using the controller, if it is determined that the logical volume is not present in the virtual storage region, whether the mount request is a write request; and notifying, if it is determined that the mount request is a write request, the host system of completion of the mounting without reading the requested logical volume from a physical tape library that is externally connected to the virtual tape server into the virtual storage region.

### BRIEF DESCRIPTION OF THE SEVERAL VIEWS OF THE DRAWINGS

FIG. 1 is a block diagram illustrating a computer system according to an embodiment of the present invention.

FIG. 2 is a block diagram illustrating the details of a virtual tape server according to an embodiment of the present invention.

FIG. 3 is a flowchart showing an example of a method for writing data into the virtual tape server.

FIG. 4 is a flowchart showing an example of a method for reading data from the virtual tape server.

FIG. 5 is a flowchart showing a method for reducing a mounting time according to an embodiment of the present invention.

FIG. 6 is a flowchart showing an example of a process for determining whether a mount request from a host is a write request according to and embodiment of the present invention.

FIG. 7 is a flowchart showing an example of a method for collecting mount statistics data of a logical volume.

FIG. 8 is a flowchart showing a method of the virtual tape server for predicting the next mounting time from a mount statistics record.

FIG. 9 is a flowchart showing an example of a method for updating the schedule of predictive mounting time for pre-mounting.

FIG. 10 is a flowchart showing an example of a method for updating the schedule of pre-mounting.

FIG. 11 is a flowchart showing an example of a pre-mounting execution process.

### DETAILED DESCRIPTION

One embodiment of the present invention provides a method for notifying completion of mounting to a host system and a virtual tape server (VTS) that implements the method without copying the data of a LVOL into a virtual storage region (hereinafter referred to as a cache) of the VTS from a physical tape in a physical tape library connected to the VTS even if the LVOL data is not present in a disk device (DASD) serving as the cache in the case where, when the VTS receives a logical volume (LVOL) mount request from the host system, it is determined (or supposed) that the mounting of the LVOL is aimed at writing.

Another embodiment of the method further provides steps for determining the aim of a logical volume (LVOL) mount request to be writing by detecting the periodicity of the mount request on the basis of read and write statistics information and when the improbability of reading in the period is greater than or equal to a threshold value.

A further embodiment of the invention provides a method of a virtual tape server (VTS) for processing a mount request from a host system. This method includes the steps of receiving a logical-volume (LVOL) mount request from the host system using a virtual-tape drive (VTD) of the virtual tape server; determining whether the logical volume is present in a cache of the virtual tape server using a controller in the virtual tape server connected to the virtual-tape drive; determining using the controller, if it is determined that the logical volume is not present in the cache, whether the mount request is a write request; and notifying, if it is determined that the mount request is a write request, the host system of completion of the mounting without reading the requested logical volume from a physical tape library that is externally connected to the virtual tape server into the cache.

Preferably, the step of determining whether the mount request is a write request includes the step of determining that the mount request is a write request using the controller on the basis of that the virtual-tape drive has a write-only attribute setting.

Preferably, the step of determining whether the mount request is a write request includes the step of determining that the mount request is a write request using the controller if a write-only flag is set in the data information of the logical volume.

More preferably, the step of determining whether the mount request is a write request includes the step of determining whether the mount request is a write request based on the statistics information of a logical volume requested from the host system, the step including the step of determining the periodicity of reading generation time interval using the statistics information and, if there is the periodicity, the step of comparing the improbability of reading during the generation time interval with a predetermined threshold value, and in the comparison, if the improbability of reading is greater than or equal to the threshold value, including the step of determining that the request is a write request using the controller.

Preferably, the step of determining whether the mount request is a write request includes the steps of calculating the predicted value of the next mounting time of the logical volume requested from the host system on the basis of the statistics information of the logical volume; and mounting a physical volume corresponding to the logical volume to the physical tape library in advance on the basis of the predicted value in accordance with a set time.

Preferably, the statistics information is a mount statistics record including logical volume name, most recent mounting time, and mount periodicity data, the mount statistics record being stored in a virtual-tape information database connected to the controller and being registered and updated on the basis of the data of the requested logical volume.

The setting of the write-only attributes is updated by a command input from an operation terminal that is externally connected to the virtual tape server to the controller or a command input from the host system to the virtual-tape drive.

In another embodiment of the method, if the logical volume is present in the cache, the virtual tape server notifies the host system of completion of the mounting; and if it is not determined that the mount request is a write request, the host system is notified of completion of the mounting after the requested logical volume is read from the physical tape library into the cache. The mount request from the host system is a specific-volume mount request that designates a specific tape volume.

A still further embodiment of the present invention provides a virtual tape server (VTS) that processes a mount request from a host system. The virtual tape server includes at least one virtual-tape drive (VTD) that receives a logical-volume (LVOL) mount request from the host system; a cache that stores the logical volume; and control means connected to the virtual-tape drive and determining whether the logical volume is present in the cache, and if it is determined that the logical volume is not present in the cache, determining whether the mount request is a write request, wherein if it is determined that the mount request is a write request, the control means notifies the host system of completion of the mounting without reading the requested logical volume from a physical tape library that is externally connected to the virtual tape server into the cache.

The determination of whether the mount request is a write request is based on at least the setting of a write-only attribute of the virtual-tape drive or the setting of a write-only flag in the data information of the logical volume.

Preferably, the determination of whether the mount request is a write request is based on the statistics information of a logical volume requested from the host system, in which the periodicity of reading generation time interval is determined using the statistics information and, if there is the periodicity, the improbability of reading during the generation time interval is compared with a predetermined threshold value, wherein if the improbability of reading is greater than or equal to the threshold value, the controller determines that the request is a write request.

Preferably, the control means includes a data-transfer control section connected to a virtual-tape drive information database and a virtual-tape information database and controlling data transfer to and from the cache; and a library control section that controls access to the physical tape library that is externally connected to the virtual tape server.

Preferably, the virtual-tape drive information database includes mapping information on the virtual-tape drive and a tape drive in the physical tape library and a write attribute table of the virtual-tape drive corresponding to the host system, the attribute table discriminating whether the virtual-tape drive is a write-only drive; the virtual-tape information database includes an attribute table of the logical volume and a mount statistics record including the statistics information of the mount request; and the virtual-tape information database further includes a predictive mount table that the virtual tape server refers to when performing pre-mounting, the predictive mount table including the correspondence relationship between logical volume name and predictive mounting time.

Preferably, the virtual-tape drive has a write-only attribute setting in correspondence with the host system that has made the mount request, the write-only attribute being updated on the basis of an input from an operation terminal or the host system which are externally connected to the virtual tape server; and the write-only flag of the logical volume is set when a mount request from the host system is made.

When a prior art virtual tape server (VTS) receives a logical volume (LVOL) mount request from a host system and if the LVOL is not present in a cache, it takes several minutes to mount the LVOL. The present invention allows the mounting of the LVOL to be completed in several seconds by determining that the data of the LVOL is not read, thus enhancing mounting performance. Furthermore, the method according to the present invention is useful particularly in rewriting all the data of the LVOL, such as in backup.

By reducing the tape mounting time of the virtual tape server in response to a mount request from a host system or by performing pre-mounting efficiently, a VTS that uses conventional tape operation management can also achieve a reduction in tape mounting time.

Some embodiments of the invention reduce a recall process in response to the host application making a specific-volume mount request to thereby reduce a mounting time in application execution scheduling.

Furthermore, some embodiments of the present invention reduce a mounting time in a virtual tape server (VTS) without copying data on a logical volume (LVOL) from a physical tape to a cache serving as a virtual storage region in response to determining that writing is the object of a mount request received from a host system.

Other embodiments of the present invention reduce a logical-volume mounting time without affecting the mount performance when another host system uses a logical volume by reducing unnecessary access to a cache by not expanding the logical volume in the cache in advance.

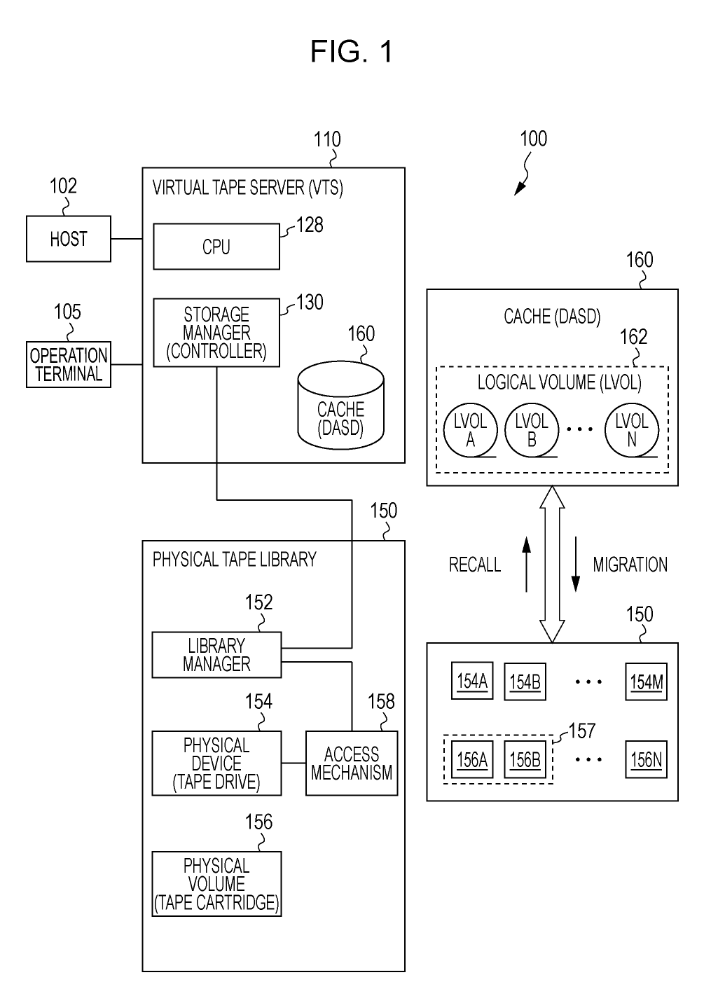

FIG. 1 is a block diagram illustrating a computer system 100 according to an embodiment of the present invention. In this computer system 100, a virtual tape server (hereinafter abbreviated to VTS) 110 is connected between a host computer (hereinafter abbreviated to host) 102 and a physical tape library 150. This physical tape library 150 includes a plurality of tape cartridges (also referred to as physical volumes or physical tapes) 156 and a tape drive (physical device) 154 that is a driving mechanism therefor. In FIG. 1, although one host 102 is connected to the VTS 110, a plurality of hosts 102 may be connected to one VTS. The VTS 110 emulates virtual tape, that is, a logical volume, as a file, to a direct access storage device (DASD), that is, a cache 160. The DASD may include a large number of mutually connected hard disks and functions as a cache for the physical volumes in the physical tape library 150. The VTS 110 is any server known in the art and may include any operating system known in the art.

For example, the host 102 performs input/output operations to the physical tape library 150 by performing I/O operations on the cache 160 that emulates the physical tape library 150. At least one VTS 110 is connected to the physical tape library 150 including a plurality of tape drives (physical devices) 154 and tape cartridges (physical volumes) 156. The VTS 110 processes a request from the host 102 and accesses data on a logical volume (LVOL) 162 in the tape cartridges 156 or returns data on the host's request from the cache 160 to the host 102 if possible. If the LVOL 162 is not present in the cache 160, the VTS 110 recalls the LVOL data from the physical tape library 150 to the cache 160. In other words, the LVOL 162 transfers the LVOL data to the cache 160. The VTS 110 can thus respond to the host's request for a volume that needs to be recalled from the physical tape library 150 to the cache 160 substantially quickly by using a volume present in the cache 160.

Accordingly, in the case where a frequently accessed volume is stored in the cache 160, I/O requests can be satisfied quickly. However, since the capacity of the cache 160 is smaller than that of the physical tape library 150, not all the volumes can be stored in the cache 160. Accordingly, the VTS 110 transfers (migrates) data from the cache 160 to the tape cartridge (also referred to as a physical volume) 156 in the physical tape library 150 in advance. The volumes that are migrated in advance are finally removed from the cache 160 and are abbreviated to pointers indicating data in the tape cartridge 156, thus providing a space for new data in the cache 160. Since this abbreviating operation is performed at a very high speed, the bottleneck of the performance of the VTS 110 is the advance migrating operation itself.

As shown in FIG. 1, one or a plurality of hosts 102 and one of a plurality of operation terminals (operator interfaces) 105 are connected to the VTS 110. The host 102 and the operation terminal 105 may be any apparatus known in the art, such as a personal computer, workstation, server, and mainframe.

The VTS 110 includes, in addition to the above-described cache 160, at least one central processing unit (CPU) 128 for controlling the VTS 110 and a control program, such as a controller (hereinafter referred to as a storage manager) 130 that optimizes the amount of storage used. The CPU 128 controls data transfer and manages information related to logical volumes (also referred to as LVOLs, logical tape volumes, or virtual tape volumes) in the VTS 110. Furthermore, the CPU 128 processes mount statistics data related to logical volumes according to the present invention. The CPU 128 also performs drive control, such as mounting and unmounting of a physical tape (magnetic tape or the like) 156 to/from the physical tape library 150 and feeding and reversing of the physical tape 156.

The storage manager 130 serving as a controller can be implemented as either an independent application or part of one or a plurality of other applications. The storage manager 130 controls access to the cache 160 formed of a DASD and to the physical-tape library unit 150. The storage manager 130 controls data transfer among the host 102, the cache (DASD) 160, and the physical tape library 150. The physical tape library 150 includes a library manager 152 that transfers data to/from the storage manager 130 and manages physical tapes, the physical volume (hereinafter also referred to as a physical tape) 156 including a tape cartridge, the physical device 154 including a tape drive, and an access mechanism 158 to the physical device 154. As shown in FIG. 1, the physical tape library 150 can generally include a plurality of physical volumes 156 (156A to 156N) and a plurality of physical devices 154 (154A to 154M).

The cache 160 can be a DASD (direct-access storage device) including a large number of mutually connected hard disk drives. The cache 160 can store the logical volumes (LVOLs) 162. The performance of the VTS 110 can be improved by processing I/O requests from the host 102 to the physical tape library 150 using the cache 160 that is accessible at a higher speed. The disks in the cache 160 can also be redundant array of independent disks (RAID) or the like.

The host 102 performs various tape operations with the VTS 110. The tape operations include searching the logical volumes 162 stored in the cache 160 for data and storing data in the logical volumes 162. The VTS 110 automatically migrates (that is, offloads) a logical volume 162 in the cache 160 after the physical volumes 156 are accessed by the host 102. If one of the hosts 102 needs a logical volume 162 that is not present in the cache 160, the storage manager 130 in the VTS 110 instructs the physical tape library 150 to mount an appropriate physical volume (for example, a tape cartridge) 156 into the physical device (for example, a tape drive) 154. Next, the requested LVOL data is copied from the physical volume 156 (that is, the LVOL data is recalled) as a logical volume 162 in the cache 160.

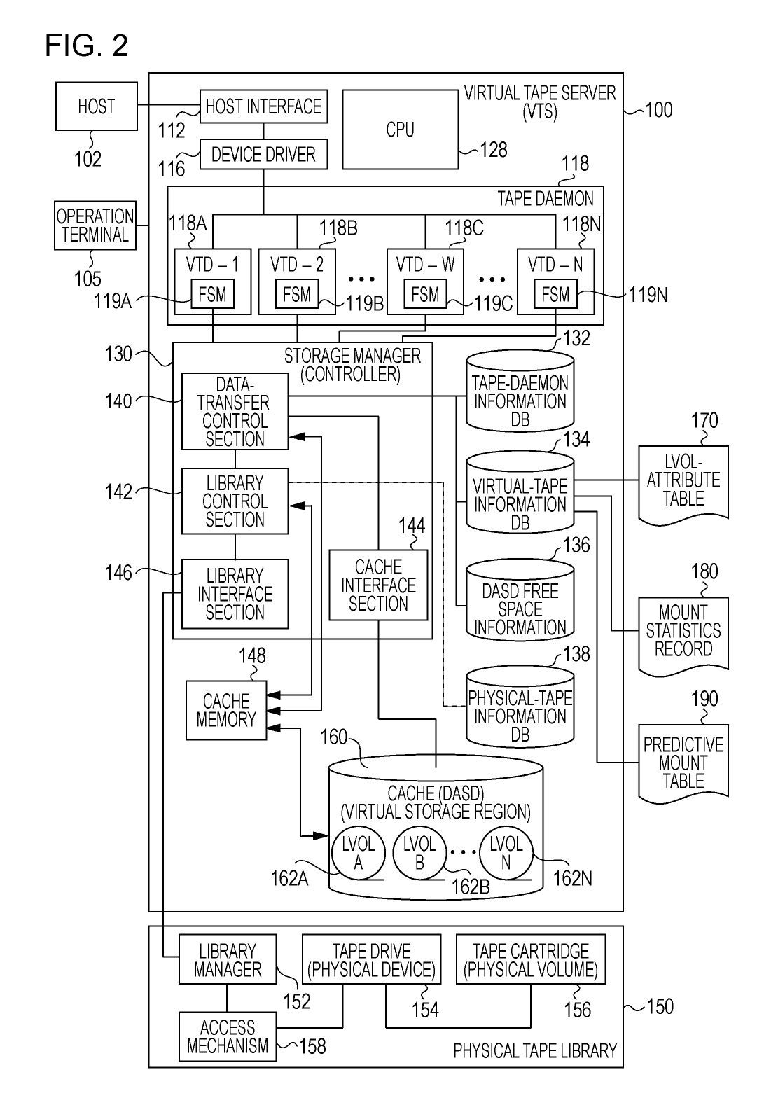

FIG. 2 is a block diagram illustrating the details of a virtual tape server (VTS) according to an embodiment of the present invention. The virtual tape server (VTS) 110 includes the CPU 128, a tape daemon 118 serving as a virtual-tape drive (VTD), the storage manager 130 serving as a controller, the cache 160 formed of, for example, a DASD, and various kinds of databases (132, 134, 136, and 138). The VTS 110 releases (presents), to the host 102, tape daemons VTD-1 to VTD-N that are general-use virtual-tape drives (VTDs) for which a determination of whether they are used for data reading or data writing cannot be made by the host 102 and a tape daemon VTD-W that is a virtual-tape drive, according to the present invention, that is set only for writing for a predetermined host 102. The VTS 110 may include a plurality of write-only tape daemons. In the case where a plurality of hosts 102 are connected to the VTS 110, a write-only or a general-use tape daemon may be set for the individual hosts 102.

The virtual tape server (VTS) 110 is connected to the host 102 via a host interface 112 to communicate with the host 102. This host interface 112 may be one of various host interfaces, such as an enterprise system (ESCON®) adapter (ESCON is a trademark of International Business Machines Corporation) and switching mechanisms known in the art (for example, a fiber channel and a storage area network (SAN) mutual connection).

Tape daemons 118A to 118N that function as virtual-tape drives (VTDs) are connected to the host 102 via a device driver 116 connected to the host interface 112. The virtual-tape drives (VTDs), that is, the tape daemons 118A to 118N, receive tape reading and writing operations from the host 102 via one or a plurality of host interfaces 112. For a writing operation, the tape daemons 118A to 118N receive data, create the logical volumes 162, and write the logical volumes 162 into the cache 160 as files. For a reading operation, the tape daemons 118A to 118N access the cache 160, search for LVOL data through a client kernel extension (not shown, part of a cache interface section 144 in FIG. 2), and returns the LVOL data to the host 102. The VTS 110 operates as if the host 102 communicates not with the tape daemons 118A to 118N that emulate the physical tape drive 154 but with the tape drive 154. The tape daemons 118A to 118N include file system managers (FSMs) 119A to 119N for use in accessing files in the cache 160, respectively.

The storage manager 130 that is a controller for the VTS 110 implements control programs for a data-transfer control section 140 and a library control unit 142. In response to a write request from the host 102, the data-transfer control section 140 records data transferred from the host 102 onto a LVOL 162 in the cache 160 via a cache memory 148 as necessary or onto the tape cartridge 156 that is a physical volume by starting the library control section 142 to drive the physical tape library 150. At that time, the storage manager 130 refers to or updates a tape-daemon information database (that is, a virtual-tape drive information database) 132, a virtual-tape information database 134, DASD (virtual storage region) free space information 136, and a physical-tape information database 138. In response to a read request from the host 102, the data-transfer control section 140 reads LVOL data 162 from the cache memory 148 or from the tape cartridge 156 as necessary and transfers the LVOL data to the host 102.

The virtual-tape information database 134 stores a logical-volume information table including tape-volume information records. One tape-volume information record is created for one logical volume 162 provided in the cache (virtual storage region) 160.

The individual records in the logical volume (LVOL) information table can include various information fields. For example, this record includes various fields, such as “LVOL (tape volume) name” indicating the name of a logical volume 162, “header information”, “total block size” indicating the block size of the logical volume 162, “tape creation time” indicating the time the logical volume 162 was created, “last access time” indicating the time the logical volume LVOL 162 was accessed last, “last writing time” indicating the time the logical volume LVOL 162 was accessed for writing last, “last mounting time” indicating the time the logical volume was mounted last, “migration time” indicating the time the logical volume was migrated, “number of mountings” indicating the number of times of mounting, a plurality of items of “tape mark information” indicating the positional information of address pointers, and “write-only flag” according to an embodiment of the present invention indicating whether the logical volume 162 is only for writing.

The data-transfer control section 140 of the storage manager 130 transfers LVOL data from the cache 160 to the tape drives 154A to 154M in the physical tape library 150 externally connected to the VTS 110. In one embodiment, as shown in FIG. 2, the data-transfer control section 140 controls data transfer from the cache 160 to the tape drives 154A to 154M. Furthermore, the data-transfer control section 140 controls the speed at which the tape daemons 118A to 118N write data into the cache 160.

To enhance data access efficiency, the cache memory 148 may be disposed between the storage manager 130 and the cache 160 to temporarily store data read or write from/to the cache 160 and the physical tape volume 156.

The data-transfer control section 140 receives a data transfer notification from one of the hosts 102. The host 102 indicates which logical volume 162 is disposed in a specific pool of the tape cartridges 156A to 156N. Furthermore, the data-transfer control section 140 exchanges data among the tape-daemon (virtual-tape drive) information database (TDDB) 132, the virtual-tape information database (VTDB) 134, and the DASD free space information 136. The tape-daemon information database 132 includes mapping information on the tape daemon 118 and the physical tape drives 154 and can further include attribute-data information table (including write-only attribute data according to the present invention) of the tape daemon (hereinafter abbreviated to VTD) 118. The virtual-tape information database 134 can include an attribute table 170 for the logical volumes (LVOLs) 162 (an attribute table for referring to a write-only flag in the LVOL data), a mount statistics record 180 that is statistics data related to mount request information, and a predictive mount table 190 in which predictive mounting times for pre-mounting are tabulated. The DASD free space information 136 can include information on the arrangement of LVOLs 162 in the cache 160.

The data-transfer control section 140 instructs the cache interface section 144 to transfer data. The cache interface section 144 searches the cache 160 for requested data and sends the data to a tape data server (not shown) in the data-transfer control section 140. The cache interface section 144 is an interface between the tape daemon 118 and the cache (DASD) 160 and includes a client kernel extension (not shown) that searches the cache 160 for the requested data and sends the data to the tape data server in the data-transfer control section 140.

The tape data server in the data-transfer control section 140 controls data writing to the tape drives 154A to 154M. The data is sent from the tape data server to the tape drives 154A to 154M via a library interface section 146 (for example, an Atape driver and an SCSI adapter). The tape data server notifies the library manager 152 via the library interface section 146 which tape cartridge 156 is disposed in which of the physical tape drives 154. The data-transfer control section 140 sends the message to the library manager 152 via the library control section 142.

The library control section 142 is connected to the physical-tape information database 138. The physical-tape information database 138 stores an information table of the physical volumes 156, for example. The library control section 142 can be programs for controlling the driving of a robot that mounts and unmounts the tape cartridge 156 and for controlling the feeding and reversing of a mounted magnetic tape by driving a tape feed mechanism in the physical tape library 150.

The library manager 152 of the physical tape library 150 manages the mounting and unmounting of the tape cartridges 156A to 156N to/from the tape drives 154A to 154M. The data-transfer control section 140 selects an appropriate physical tape cartridge 156 and mounts it on the basis of a relationship with an accessed or written logical volume 162. Upon reception of a notification to mount or unmount the tape cartridge 156, the library manager 152 sends the notification to the access mechanism 158 for use in accessing the tape drives 154A to 154M. The access mechanism 158 mounts or unmounts the tape drives 154A to 154M.

Next, referring again to the block diagram of FIG. 1, the relationship among the VTS 110, the cache 160, and the physical-tape library 150 will be described. The physical tape library 150 includes the physical volumes (physical tapes) 156A to 156N, in addition to the physical devices 154A to 154M. The physical volumes 156A to 156N can also be mounted in any of the physical devices 154A to 154M. The physical volumes 156A to 156N include tape cartridges that can be mounted (that is, physically mounted) to the physical devices 154A to 154M that are tape drives. As an alternative embodiment, the physical volumes 156A to 156N can be CD-ROMs, DVDs, or other storage media. In a specific embodiment, the number of physical volumes 156A to 156N is larger than the number of physical devices 154A to 154M. The physical devices 154A to 154M may be organized in a pool. For example, the physical volumes 156A and 156B may be disposed in a pool 157.

Operations performed between the cache 160 and the physical devices 154A to 154M are a migration or transfer of data from the cache 160 to the physical volumes 156A to 156N and a recall that is a data transfer from the physical volumes 156A to 156N to the cache 160. The size of a general data file is between 100 and 200 megabytes. In general, since there are more physical volumes 156A to 156N (corresponding to the logical volumes 162 stored in the logical device) than the physical devices 154A to 154M, more physical volumes 156A to 156N than the physical devices 154A to 154M in the VTS 110 are sometimes mounted for recall. This sometime requires removing a physical volume 156 to allow the other physical volumes 156A to 156N to be mounted.

In the case where a logical volume 162 that the host 102 requests from the VTS 110 is present in the cache 160, a cache hit occurs. If the logical volume 162 is not present in the cache 160, the storage manager 130 determines whether corresponding one of the physical volumes 156A to 156N is mounted to one of the physical devices 154A to 154M. If the corresponding one of the physical volumes 156A to 156N is not mounted, the storage manager 130 operates to mount the corresponding one of the physical volumes 156A to 156N to one of the physical devices 154A to 154M. The data on the logical volume 162 is transferred again (that is, recalled) from the corresponding one of the physical volumes 156A to 156N. In a specific embodiment, the recall operation sometimes takes several minutes, and the recall waiting time can include the time for a robot arm to access a tape cartridge and insert the tape cartridge into a tape drive and positioning time for disposing the tape in a desired position.

The storage manager 130 maps the logical volumes 162 to the physical volumes 156A to 156N. The logical volumes 162A to 162N corresponding to the physical volumes 156A to 156N may be present in the cache 160. In FIG. 1, the cache 160 includes the logical volumes 162A to 162N. The logical volumes 162A to 162N in the cache 160 can change with a lapse of time. The storage manager 130 attempts to keep the possibility of using the logical volumes 162A to 162N in the cache 160 high.

When the host 102 writes a logical volume LVOL 162 in the VTS 110, the data is stored in the cache 160 as a file. The data stored in the cache 160 is later migrated to one of the physical volumes 156A to 156N. When the cache 160 is filled to a predetermined threshold value, the data on the selected logical volume 162 is removed from the cache 160 to provide a space for much more logical volumes 162. The cache 160 may always store several records of the heads, that is, inner labels, of the individual logical volumes 162.

In a specific embodiment, the storage manager 130 removes a logical volume 162 that has been present in the cache 160 for the longest time (that is, a logical volume 162 that has not been used for the longest time) from the cache 160.

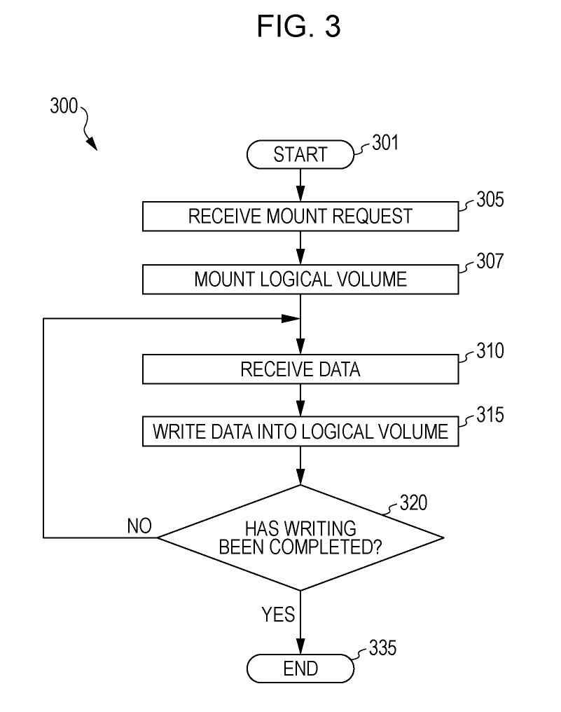

An example of a standard writing sequence that the VTS 110 can use to write data is shown in a flowchart 300 of FIG. 3. The process of the writing sequence is started from step 305 in which the device driver 116 receives a mount command and a write command from the host 102 together with data on the tape daemons 118A to 118N. In step 307, the storage manager 130 mounts a requested logical volume 162 for writing. The mounting of the logical volume 162 can include opening, positioning, reversing, and other all operations for placing the logical volume 162 in a correct position relative to the beginning of the logical volume 162 in a state in which data can be read and written. The host 102 sends a data object and a write command in the form of a storage request. The data object can include a logical volume, file, physical volume, logical device or physical device, sector, page, byte, bit, or other appropriate data units.

Next, in step 310, the tape daemons 118A to 118N receives the data and sends the data to the storage manager 130. In step 315, the storage manager 130 writes the data object into the cache (DASD) 160 and/or the physical volume 156 in the physical tape library 150. The storage manager 130 can also write data related to several information databases (the tape-daemon information database 132, the virtual-tape information database 134, the DASD free space information 136, and the physical-tape information database 138) (the data may be temporarily stored in the cache memory 148). In step 315 or in another appropriate step, the data object can also be copied between a data main storage and a data backup storage.

If the writing operation has not been completed, then step 310, step 315, and step 320 are repeated as necessary. Upon completion of the writing operation, the storage manager 130 may encapsulate the metadata of the present data object. The encapsulation of the metadata includes collecting various metadata subcomponents and combining them into an appropriate form for storage. Such encapsulation involves connection, integration, coding parts into an integrated form, and encoding. The metadata is associated with a logical volume 162 in which data corresponding to the metadata is stored. Furthermore, the metadata may be written to the cache 160 and/or another storage (database) together with the data object written in step 315, depending on the type of appropriate data management policy. Finally, the writing sequence 300 ends in step 335.

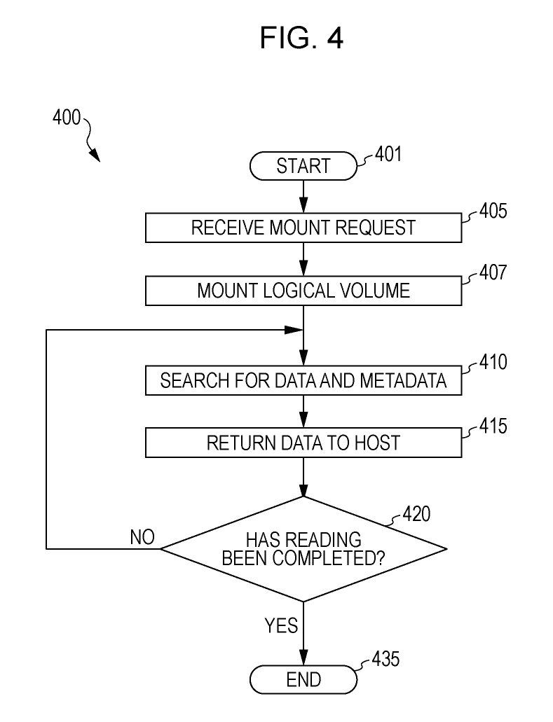

An example of a standard reading sequence that the VTS 110 can use to read data is shown in a flowchart 400 in FIG. 4. The process in the flowchart 400 is an example of a process for obtaining information from the VTS 110, however another process may be used. The reading sequence 400 is started when the device driver 116 has received a request to mount a specific logical volume 162 from the host 102 (step 405). In response to the reception of the mount request from the host 102, the device driver 116 sends the read request to the tape daemons 118A to 118N and the storage manager 130. In step 407, it is determined whether the logical volume 162 is present in the cache 160, and if the logical volume 162 is not present in the cache 160, a physical tape cartridge 156 related to the requested logical volume 162 is mounted for reading. In step 410, data and metadata on the logical volume LVOL 162 is read. In step 415, the read data is returned to the host 102. In step 420, the state of reading of the requested logical volume LVOL 162 is checked to determine whether the reading has been completed. If the reading has been completed, the control moves to step 435. If the reading has not been completed, then step 410, step 415, and step 420 are repeatedly executed until the reading is completed, and upon completion, the process ends in step 435.

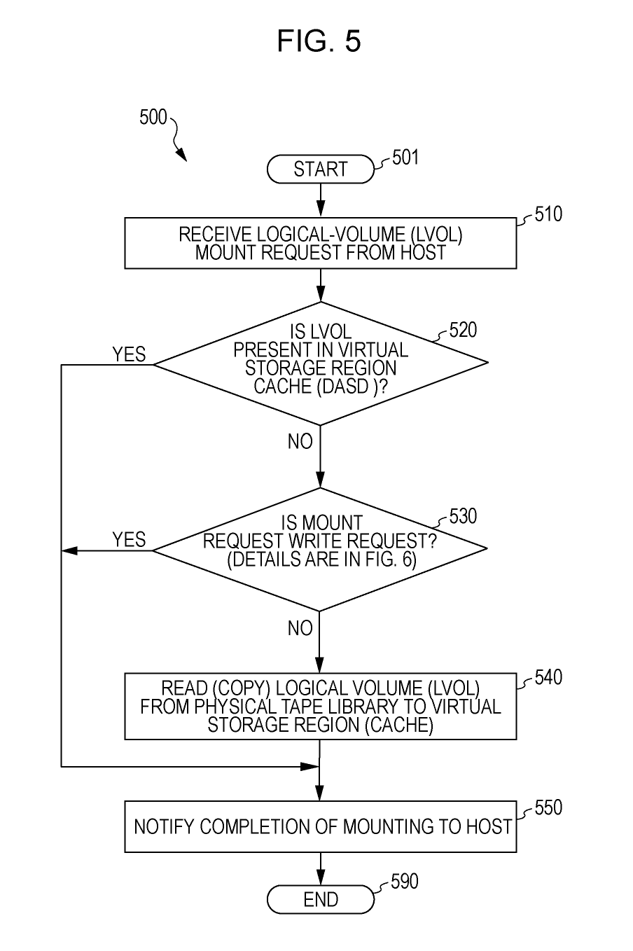

An example of a process flow of the outline of an embodiment of the present invention is shown in a flowchart 500 of FIG. 5. This is the outline of a method for reducing mounting time without copying LVOL data from (the physical volume 156 in) the physical tape library 150 to the cache 160 in the case where it is determined that an LVOL mount request that the VTS 110 has received from the host 102 is aimed at writing, and even if the LVOL data is not present in the cache 160 (DASD, disk) serving as a virtual storage region.

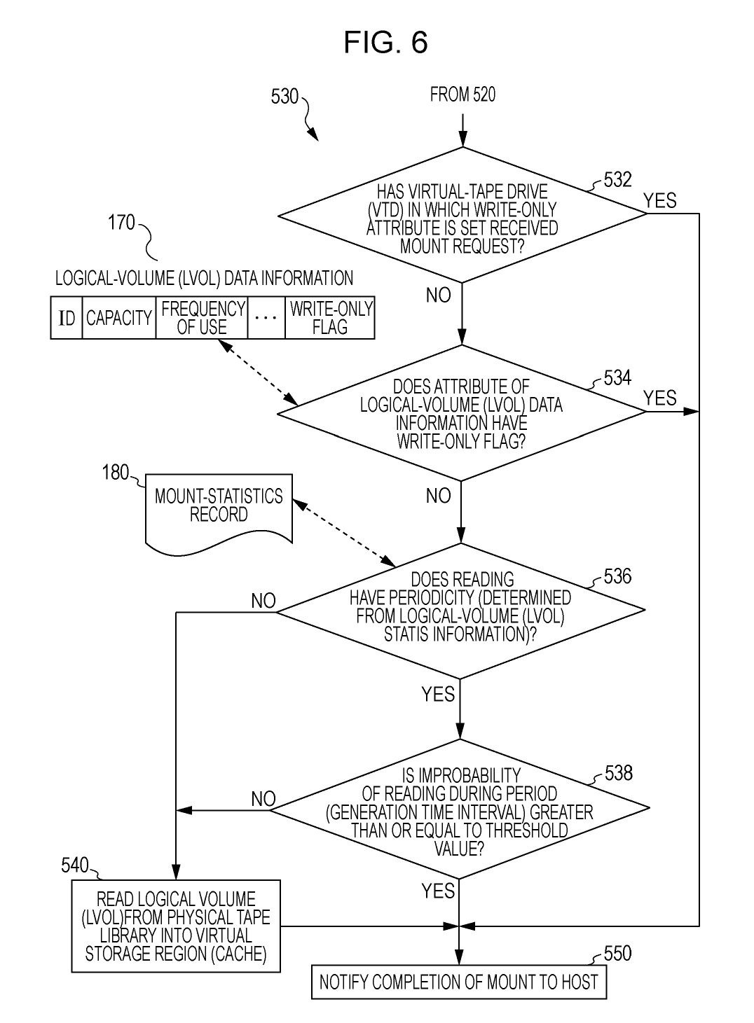

Referring to FIG. 2, the process flow 500 of FIG. 5 according to this embodiment will be described below. In step 510, the tape daemon 118, that is the virtual-tape drive (VTD), receives a logical volume 162 mount request from the host 102 that is externally connected to the VTS 110 via the host interface 112 and the device driver 116. Next, in step 520, the storage manager 130 serving as a controller and connected to the virtual-tape drive 118 determines whether the requested logical volume 162 is present in the cache (DASD) 160, that is a virtual storage region with reference to the DASD free space information 136. If it is determined that the LVOL 162 is present in the cache 160, the storage manager 130 notifies the host 102 of completion of the mounting in step 550. If it is determined by the control unit in step 520 that the LVOL 162 is not present in the cache 160, the process moves to step 530, and the storage manager 130 determines whether the mount request is a write request. This step 530 will be described later in detail using FIG. 6. In step 530, if the storage manager 130 determines that the mount request is a write request, the storage manager 130 notifies the host 102 of completion of the mounting without reading (copying) the LVOL data from the physical tape library 150 to the cache 160 (step 550).

In step 530, if it is determined that the mount request is not a write request, a physical volume 156 corresponding to the requested LVOL 162 is inserted into the tape drive 154 using the access mechanism 158, and the requested LVOL data is read (copied) into the cache 160 by the library control section 142 of the storage manager 130 via the library manager 152 in the physical tape library 150, as a normal operation (step 540). Thereafter, the storage manager 130 notifies the host 102 of completion of the mounting (step 550). In step 590, the process ends. Subsequent to the completion of the mounting of the LVOL 162, the VTS 110 can perform the writing process (steps from step 310 in FIG. 3 onward) or the reading process (steps from step 410 in FIG. 4 onward) responding to a request from the host 102. For example, if the host 102 needs to read LVOL data information, the LVOL data information can also be read from the physical tape 156 in the physical tape library 150 to the cache 160 in the VTS 110.

In contrast to this embodiment, the conventional method is configured such that if the storage manager 130 determines in step 520 of FIG. 5 that the LVOL 162 is not present in the cache (virtual storage region) 160, the data of the LVOL 162 requested from the host 102 is copied from the corresponding physical volume (that is, physical tape) 156 in the physical tape library 150 to the cache 160 via the library control section 142 of the storage manager 130 (step 540), and after completion of the copying, the VTS 110 notifies the host 102 of completion of the mounting (step 550). In this case, even if the mount request from the host 102 is a write request, the VTS 110 needs to wait until the series of operations after completion of the mounting of the physical tape 156 to the physical tape drive 154 in the physical tape library 150 to completion of the copying of the LVOL data to the cache 160. This takes a processing time in minutes. For example, in the case where the entire LVOL data is to be rewritten, such as in backup, the series of operations described above are not necessary, which consumes the mounting time uselessly.

Step 530 in the flowchart of FIG. 5, that is, the step of determining whether the mount request from the host 102 is a write request, will be described in more detail using FIG. 6. The step of determining whether the mount request is a write request includes several steps (step 532, step 534, and steps 536 to 538), which can be performed in sequence, independently, or in combination. In step 520 of FIG. 5, if the storage manager 130 determines that the LVOL 162 is not present in the cache (DASD) 160, the process moves to step 532. In step 532, the storage manager 130 determines whether the virtual-tape drive (VTD), that is, the tape daemon 118, that has received the mount request from the host 102 has a write-only attribute setting. That is, for example, if the storage manager 130 determines that the tape daemon 118 that has received the mount request has a write-only attribute setting (for example, a VTD-W 118C in FIG. 2) with reference to the attribute table information of the tape daemon (virtual-tape drive) 118 stored in the tape-daemon information database 132 in FIG. 2, the storage manager 130 notifies the host 102 of completion of the mounting without activating the tape drive 154, that is a physical device, and the tape cartridge (also referred to as a tape medium) 156, that is a physical volume (step 550).

The tape-daemon information database 132 stores mapping information of the tape daemons 118 and the tape drives 154 in the physical tape library 150 and a virtual-tape drive attribute table indicating whether the individual tape daemons 118 are write-only for a predetermined host 102. The storage manager 130 associates a write-only virtual-tape drive 118 with the physical tape library 150 on the basis of the mapping information and the attribute table. One tape daemon 118 may be assigned as a write-only daemon to a plurality of hosts 102. Furthermore, one tape daemon 118 may be set as a write-only daemon to one host 102 and may set as a general-purpose type for both writing and reading for another host 102. The write attribute of the tape daemons 118 may also be dynamically changed by direct input from the operation terminal 105 connected to the VTS 110 or using a command from the host 102. The write attribute of the tape daemon 118 may be fixed depending on the host 102 connected to the VTS 110.

In step 532, if it is determined that the tape daemon (virtual-tape drive) 118 is not a write-only daemon, the process moves to step 534, in which the write attribute of the data information of the requested LVOL 162 is checked. That is, the storage manager 130 accesses the virtual-tape information database 134 that stores the LVOL-attribute table 170 and determines whether a write-only flag is set in the LVOL-attribute table 170. If a write-only flag is set in the LVOL-attribute table 170, the process moves to step 550, in which the storage manager 130 notifies the host 102 of completion of the mounting.

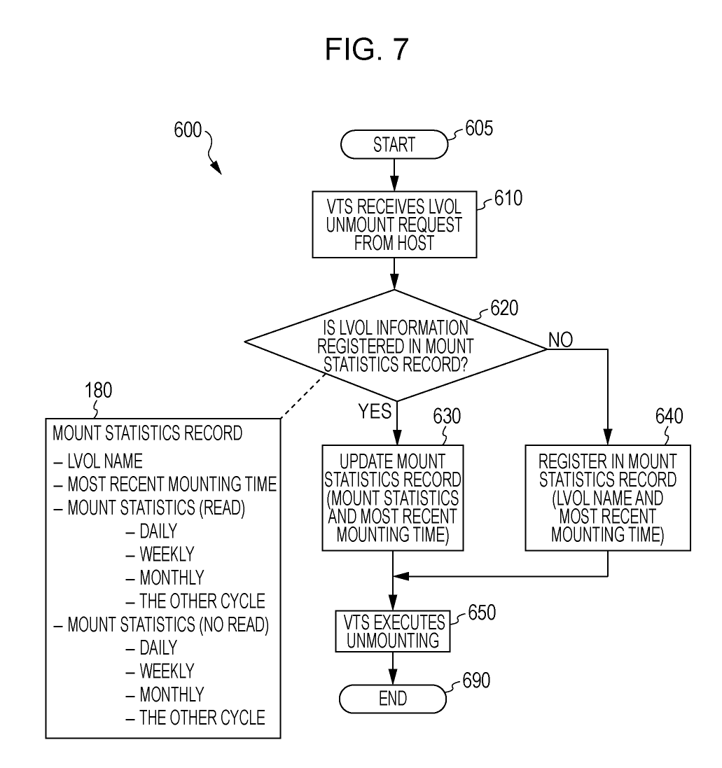

In step 534, if a write-only flag is not set in the LVOL-attribute table 170 (for example, “1” is set for write-only), the process moves to steps 536 to 538 of determining whether writing is supposed from statistics data information on the requested LVOL 162 (using the mount statistics record 180 to be described below). In step 536, the storage manager 130 first determines whether the mount request involves reading from the statistic data information of the requested LVOL 162 and the periodicity of the reading (by analyzing the mount request generation time). That is, the storage manager 130 accesses the virtual-tape information database 134 that stores the LVOL mount statistics record 180 (to be described in detail using FIG. 7) and determines whether the reading of the LVOL data falls within a predetermined zone (period) of generation time interval. Next, in step 536, if the storage manager 130 determines that the reading has periodicity, the process moves to step 538, in which the improbability of reading in the period is compared with a predetermined threshold value, and if the improbability of reading is greater than or equal to the threshold value, the process moves to step 550, in which the storage manager 130 notifies the host 102 of completion of the mounting.

If it is determined in step 536 that there is no periodicity or if the improbability of reading does not exceed the threshold value in the step 538, the process moves to step 540, in which the data of the requested LVOL 162 is read from the physical tape library 150 into cache 160. The step of reading the LVOL data into the cache 160 is performed by communicating with the library manager 152 of the physical tape library 150 via the library control section 142 of the storage manager 130 and mounting the physical volume 156 corresponding to the data of the requested LVOL 162 to the tape drive 154 using the access mechanism 158.

In this embodiment, steps 532, 534, 536, and 538, which are the steps of determining whether the request is a write request, have been described as a series of steps; instead, the steps may be performed independently or the order of the steps may be changed. For example, in the case of NO in step 532 and NO in step 534 of FIG. 6, the process may move to step 540, in which the data of the requested LVOL 162 may be read from the physical tape library 150 into the cache 160. Pre-mounting may be performed in parallel to or independently from prediction on writing from the mount-request statistics data information is referred to in steps 536 and 538 (to compensate misprediction on writing). The pre-mounting is such that the CPU 128 of the VTS 110 monitors the periodicity of the mount request and issues a command for the storage manager 130 as necessary to mount and position a physical tape 156 including the data information of the corresponding LVOL 162 to the tape drive (physical device) 154 in advance. This pre-mounting can reduce processing time for reading new LVOL data information from the physical tape 156 into the cache 160 and positioning it in the case where a read request is made from the host 102 including the case of misprediction on writing. In the pre-mounting, it is also possible to mount the physical tape 156 to the tape drive 154 but not to perform positioning. This can reduce the time for removing the physical tape 156 from the tape drive 154 in the case where there is no need to read LVOL data from the physical tape 156. Furthermore, the pre-mounting may be such that part or all of LVOL data information is read from the physical tape 156 into the cache 160 in advance after positioning. This can reduce the time for mounting the LVOL 162 in the case where LVOL data needs to be read from the physical tape 156.

Next, a method for collecting the mount statistics data of the LVOL 162 requested from the host 102 and creating and updating the mount statistics record 180 is shown in a flowchart 600 of FIG. 7. First, in step 610, the VTS 110 receives an unmount request for a related LVOL 162 from the host 102. Next, the storage manager 130 of the VTS 110 determines via the data-transfer control section 140 whether the data information of the LVOL 162 is registered in the mount statistics record 180 stored in the virtual-tape information database 134 (step 620). This mount statistics record 180 includes, for example, LVOL name, most recent mounting time, and mount statistics for individual generation time intervals (zones) for the case of reading and no reading, and predictive mounting time (to be described later in detail). In step 620, if the data of the LVOL 162 is not registered in the mount statistics record 180 (NO), at least LVOL name and most recent mounting time are registered in the mount statistics record (step 640). In step 620, if the data of the LVOL 162 is registered in the mount statistics record 180 (YES), at least LVOL name and most recent mounting time in the mount statistics record 180 are updated (step 630). Upon completion of step 630 or 640, the process moves to step 650, in which the VTS 110 unmounts the LVOL 162.

The VTS 110 can perform pre-mounting by discriminating a specific-volume mount request from the host 102 and predicting the next mounting time based on the statistics of the mount request. In other words, this allows the VTS 110 to perform pre-mounting by analyzing access for writing LVOL data and predicting the next mounting. This pre-mounting allows the VTS 110 to notify the host 102 of completion of the mounting only by mounting the tape cartridge (physical tape) 156 to the tape drive 154 without recalling the LVOL 162 to the cache (DASD) 160.

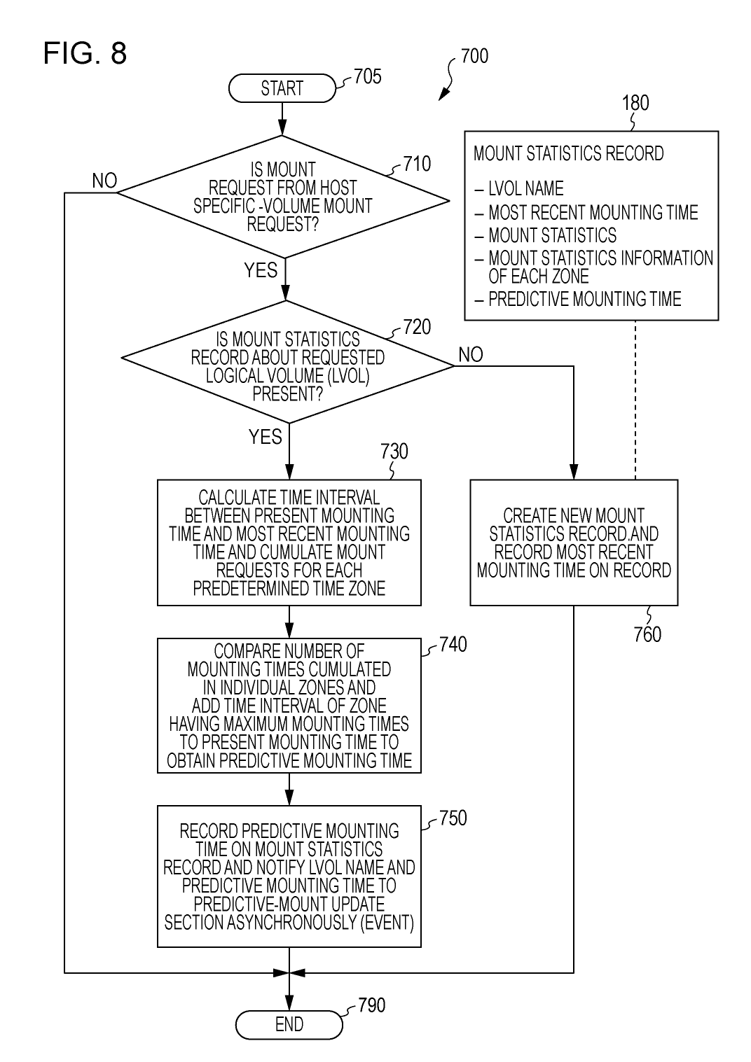

An example of the embodiment for collecting the mount statistics data of a LVOL 162 requested from the host 102 to predict the next mounting time and performing pre-mounting of the corresponding LVOL 162 using this predictive mounting time will be described using FIGS. 8 to 11. FIG. 8 shows a flowchart 700 that is a method for the VTS 110 to predict the next mounting time from a mount statistics record.

First, in step 710, the VTS 110 determines whether a mount request from the host 102 is a specific-volume mount request. If the mount request from the host application is a mount request that designates a specific logical (tape) volume, the VTS 110 can determine that the mount request is a specific-volume mount request. Next, if the mount request is determined not to be a specific-volume mount request (NO in step 710), the VTS 110 waits for the next mount request. If YES in step 710, the process moves to step 720, in which the storage manager 130 of the VTS 110 determines whether the mount statistics record 180 including the data information on the requested LVOL 162 is present. If it is determined in step 720 that the mount statistics record 180 is not present (NO), the VTS 110 creates a new mount statistics record and records the most recent mounting time on the record (step 760).

If it is determined in step 720 that the mount statistics record of the corresponding LVOL 162 is present (YES), the CPU 128 calculates the time interval between the present mounting time and the most recent mounting time, allocates the time interval to preset time zones (periodic intervals), and accumulates the number of mount requests for each time zone (step 730).

Examples of the present time zones (periodic intervals) are as follows:
12 hours+/−1 hours=>intervals of 12 hours
24 hours+/−1 hours=>intervals of one day
7 days+/−6 hours=>intervals of one week
30 day+/−1 day=>intervals of one month
365 days+/−1 week=>intervals of one year etc.

Next, the process moves to step 740, in which the VTS 110 compares the mounting times accumulated for individual time zones and adds the time interval of a zone having the maximum mounting time to the present mounting time to find a predictive mounting time indicating the predicted value of next mounting time. Next, the process moves to step 750, in which the VTS 110 records the found predictive mounting time on the mount statistics record 180 and notifies the LVOL name and the predictive mounting time to a predictive-mount update section (program) asynchronously (event). Then, the VTS 110 terminates the process (step 790). The predictive-mount update section is one of the functional programs of the data-transfer control section 140 of the storage manager 130 and updates the mount statistics record 180 stored in the virtual-tape information database 134.

The mount statistics record 180 can be a record having, for example, the fields of logical volume name, predictive mounting time, and mount statistics. These mount statistics are constituted by, for example, n arrays (n is an integer greater than or equal to 1), in which the elements of the individual arrays indicate mount intervals. In the example of step 740, the mount statistics has mount statistics information divided into five zones from m[0] (intervals of 12 hours) to m[4] (intervals of one year).

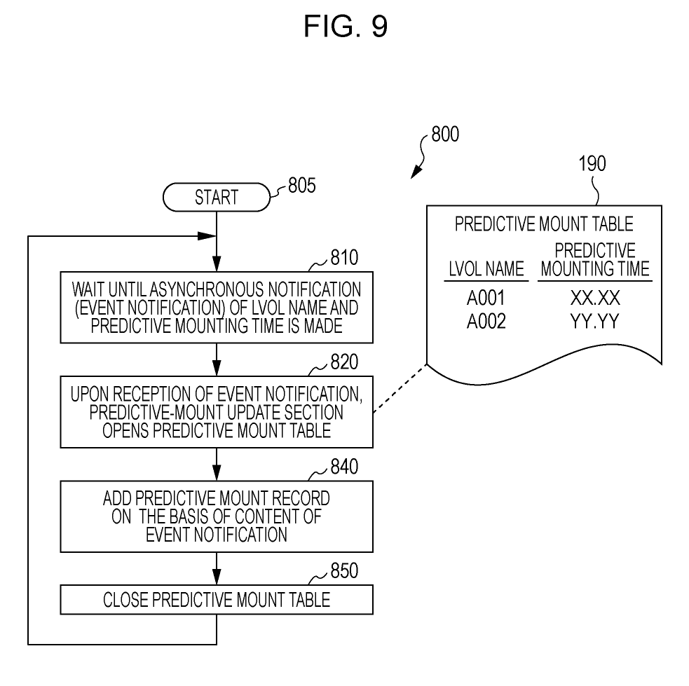

FIG. 9 shows a flowchart 800 for updating the schedule of predictive mounting time for pre-mounting. The update of the schedule of predictive mounting time is performed by the predictive-mount update section. When an asynchronous notification is given in step 750 of FIG. 8, the predictive-mount update section is started to perform the steps of the flowchart 800.

First, in step 810, the predictive-mount update section waits until an asynchronous notification (hereinafter also referred to as an event notification) of LVOL name and predictive mounting time is given. Next, upon reception of the event (asynchronous) notification, the predictive-mount update section is started to open a predictive mount table 190 stored in the virtual-tape information database 134 connected to the data-transfer control section 140 (step 820). Then, the predictive-mount update section adds a record (predictive mount record) having, at least the field of LVOL name and predictive mounting time into the predictive mount table 190 on the basis of the content of the event notification (step 840). In other words, this predictive mount record is a record that the predictive-mount update section refers to. Finally, the predictive-mount update section closes the predictive mount table 190 (step 850). Preferably, the predictive-mount update section repeats these steps 810 to 850 to update the schedule of predictive mounting time.

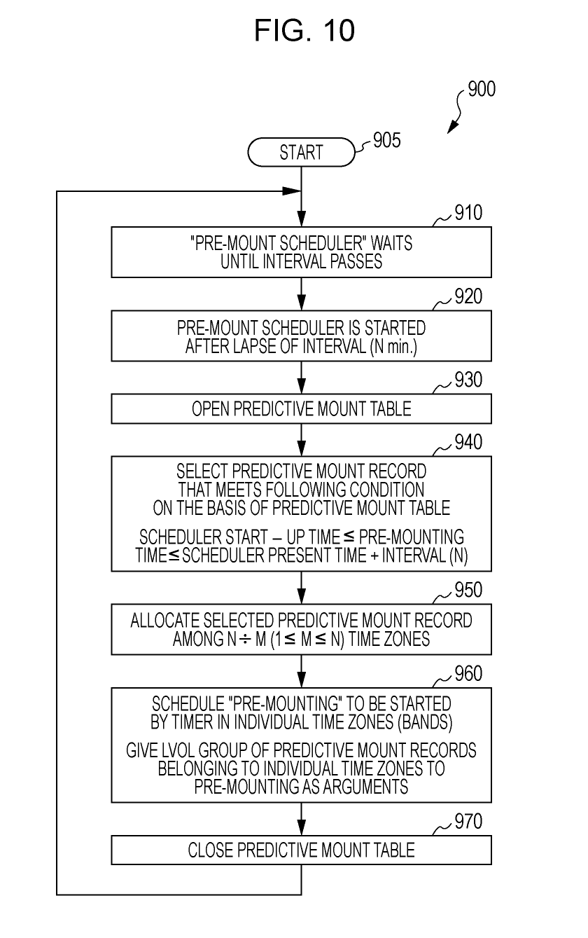

FIG. 10 shows a flowchart 900 for updating the schedule of pre-mounting. A series of processes including this pre-mount schedule management are performed by a pre-mount scheduler. This pre-mount scheduler is a program (process) that is activated every predetermined interval (N minutes in the description below). This pre-mount scheduler can be one of the functional programs of the data-transfer control section 140 of the storage manager 130.

First, in step 910, the pre-mount scheduler waits until a predetermined interval passes. Next, the pre-mount scheduler is activated after a lapse of an interval (for example, N minutes) (step 920) to open a predictive mount table 830 provided in the virtual-tape information DB 134 connected to the data-transfer control section 140 (step 930).

Next, the pre-mount scheduler selects a predictive mount record that satisfies the following condition on the basis of the predictive mount table 830 (step 940).

Scheduler start-up time pre-mounting time present scheduler time+interval (N)

The predictive mount record selected in step 940 is allocated to N+M (123 M≦N) time zones (hereinafter referred to as “bands”) (step 950). Next, the pre-mount scheduler performs schedule setting to start pre-mounting of the LVOL 162 at the individual band time under timer control. At that time, the pre-mount scheduler gives the logical volumes (group) belonging to the individual bands of the predictive mount record as arguments for pre-mounting (step 960). Finally, the pre-mount scheduler closes the predictive mount table (step 970). The pre-mount scheduler repeats these steps 910 to 970 to update the schedule of pre-mounting.

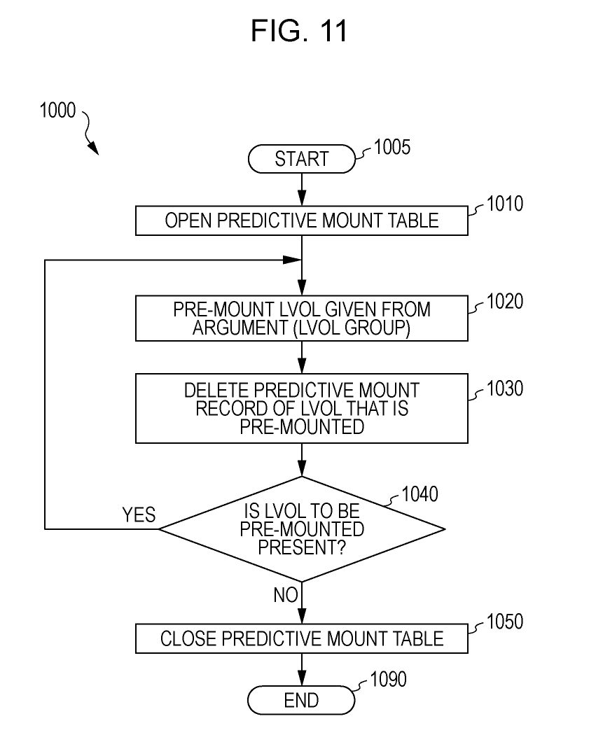

FIG. 11 is a flowchart 1000 showing a pre-mounting execution process. Pre-mounting is executed by the VTS 110 and is started by the pre-mount scheduler under timer control.

First, in step 1010, the storage manager 130 opens a predictive mount table 190 provided in the virtual-tape information database 134 connected to the data-transfer control section 140. Then, the storage manager 130 operates on the basis of the predictive mount table 190 so as to mount in advance, among the LVOLs (group) belonging to the individual bands in the predictive mount record, a physical tape 156 including the data of the LVOL 162 given as an argument (step 1020). Next, the storage manager 130 deletes a predictive mount record related to the LVOL 162 that is mounted in advance (step 1030). Then, the storage manager 130 determines whether a LVOL 162 to be subjected to pre-mounting remains (step 1040). If it is determined from an argument that a LVOL to be subjected to pre-mounting remains, the storage manager 130 repeats steps 1020 to 1040. If a LVOL to be subjected to pre-mounting is not present, the storage manager 130 closes the predictive mount table 190 (step 1050).

In this embodiment, if a logical-volume (LVOL) mount request is given to a virtual-tape drive (tape daemon) set for write-only, pre-mounting may be executed before or in parallel to a notification of completion of mounting to the host 102. However, there is no need to necessarily execute pre-mounting. If a logical-volume (LVOL) mount request is given to a virtual-tape drive set for write-only, there is no need to necessarily operate the tape drive 154 and the tape cartridge 156 of the physical tape library 150.

Note that the timing at which data is written from the host 102 to the logical volume (virtual tape, virtual tape medium) 162 and the timing at which the data is written to the physical volume (physical tape) 156 are not always the same. Furthermore, note that a physical tape 156 selected for use in writing is not uniquely identified by logical volume (LVOL) name (identifier).

According to embodiments of the present invention, when one logical volume (LVOL) is to be used by a plurality of hosts, the logical volume may be used in parallel for different purposes such that one host uses the logical volume only for writing with a virtual-tape drive (tape daemon) that is set for write-only and another host uses it for reading.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of a virtual tape server for processing a mount request from a host system, the method comprising the steps of:
receiving a logical-volume mount request from the host system using a virtual-tape drive of the virtual tape server;
determining whether the logical volume is present in a virtual storage region of the virtual tape server using a controller in the virtual tape server connected to the virtual-tape drive;
determining using the controller, if it is determined that the logical volume is not present in the virtual storage region, whether the mount request is a write request; and
notifying, if it is determined that the mount request is a write request, the host system of completion of the mounting without reading the requested logical volume from a physical tape library that is externally connected to the virtual tape server into the virtual storage region.

2. The method according to claim 1, wherein the step of determining whether the mount request is a write request includes the step of determining that the request is a write request using the controller on the basis of that the virtual-tape drive has a write-only attribute setting.

3. The method according to claim 1, wherein the step of determining whether the mount request is a write request includes the step of determining that the request is a write request using the controller if a write-only flag is set in the data information of the logical volume.

4. The method according to claim 1, wherein the step of determining whether the mount request is a write request includes the step of determining whether the mount request is a write request based on the statistics information of a logical volume requested from the host system, the step including the step of determining the periodicity of reading generation time interval using the statistics information and, if there is the periodicity, the step of comparing the improbability of reading during the generation time interval with a predetermined threshold value, wherein if the improvability of reading is greater than or equal to the threshold value, including the step of determining that the request is a write request using the controller.

5. The method according to claim 4, wherein the statistics information is a mount statistics record including logical volume name, most recent mounting time, and mount periodicity data, the mount statistics record being stored in a virtual-tape information database connected to the controller and being registered and updated on the basis of the data of the requested logical volume.

6. The method according to claim 1, wherein the step of determining whether the mount request is a write request includes the steps of:
calculating the predicted value of the next mounting time of the logical volume requested from the host system on the basis of the statistics information of the logical volume; and
mounting a physical volume corresponding to the logical volume to the physical tape library in advance on the basis of the predicted value in accordance with a set time.

7. The method according to claim 6, wherein the statistics information is a mount statistics record including logical volume name, most recent mounting time, and mount periodicity data, the mount statistics record being stored in a virtual-tape information database connected to the controller and being registered and updated on the basis of the data of the requested logical volume.

8. The method according to claim 2, wherein the setting of the write-only attributes is updated by a command input from an operation terminal that is externally connected to the virtual tape server to the controller or a command input from the host system to the virtual-tape drive.

9. The method according to claim 1, wherein
if the logical volume is present in the virtual storage region, the virtual tape server notifies the host system of completion of the mounting; and
if it is not determined that the mount request is a write request, the host system is notified of completion of the mounting after the requested logical volume is read from the physical tape library into the virtual storage region.

10. The method according to one of claims 9, wherein the mount request from the host system is a specific-volume mount request that designates a specific tape volume.

11. A virtual tape server (VTS) that processes a mount request from a host system, comprising:
at least one virtual-tape drive (VTD) that receives a logical-volume (LVOL) mount request from the host system;
a virtual storage region that stores the logical volume; and
control means connected to the virtual-tape drive and determining whether the logical volume is present in the virtual storage region, and if it is determined that the logical volume is not present in the virtual storage region, determining whether the mount request is a write request, wherein
if it is determined that the mount request is a write request, the control means notifies the host system of completion of the mounting without reading the requested logical volume from a physical tape library that is externally connected to the virtual tape server into the virtual storage region.

12. The virtual tape server according to claim 11, wherein the determination of whether the mount request is a write request is based on at least the setting of a write-only attribute of the virtual-tape drive and the setting of a write-only flag in the data information of the logical volume.

13. The virtual tape server according to claim 11, wherein the determination of whether the mount request is a write request is based on the statistics information of a logical volume requested from the host system, in which the periodicity of reading generation time interval is determined using the statistics information and, if there is the periodicity, the improbability of reading during the generation time interval is compared with a predetermined threshold value, wherein if the improvability of reading is greater than or equal to the threshold value, the controller determines that the request is a write request.

14. The virtual tape server according to claim 11, wherein
the control means includes:
(i) a data-transfer control section connected to a virtual-tape drive information database and a virtual-tape information database and controlling data transfer to and from the virtual storage region; and
(ii) a library control section that controls access to the physical tape library that is externally connected to the virtual tape server.

15. The virtual tape server according to claim 14, wherein
the virtual-tape drive information database includes mapping information on the virtual-tape drive and a tape drive in the physical tape library and a write attribute table of the virtual-tape drive corresponding to the host system, the attribute table discriminating whether the virtual-tape drive is a write-only drive; and
the virtual-tape information database includes an attribute table of the logical volume and a mount statistics record including the statistics information of the mount request.

16. The virtual tape server according to claim 15, wherein the virtual-tape information database further includes a predictive mount table that the virtual tape server refers to when performing pre-mounting, the predictive mount table including the correspondence relationship between logical volume name and predictive mounting time.

17. The virtual tape server according to claim 12, wherein
the virtual-tape drive has a write-only attribute setting in correspondence with the host system that has made the mount request, the write-only attribute being updated on the basis of an input from an operation terminal or the host system which are externally connected to the virtual tape server; and
the write-only flag of the logical volume is set when a mount request from the host system is made.
